(19) United States
(12) Patent Application Publication
(10) Pub. No.: US 2011/0101736 A1
(43) Pub. Date: May 5, 2011

(54) REAR STRUCTURE FOR AUTOMOBILE

(75) Inventor: Katsumasa Sogame, Irvine, CA (US)

(73) Assignee: Mazda Motor Corporation, Hiroshima (JP)

(21) Appl. No.: 12/608,899

(22) Filed: Oct. 29, 2009

(51) Int. Cl. B62D 25/08

(52) U.S. Cl. 296/203.04

(57) ABSTRACT

A rear structure for an automobile is provided. One exemplary rear structure includes an interior pressure release vent disposed in a rear cargo compartment in a rear part of the automobile. The interior pressure release vent discharges air from a passenger compartment and the rear cargo compartment to an outside of the automobile. The rear structure may also include a cargo cover disposed above the rear cargo compartment to divide the rear cargo compartment from the passenger compartment. The cargo cover has a mesh portion with reticulated through-holes passing through the cargo cover in a vertical direction. Further, a water receptor is disposed below the mesh portion of the cargo cover and above a floor of the rear cargo compartment, such that the water receptor is positioned to receive water drops from the dripping-wet personal effect that is put on the mesh portion.

### FIELD OF THE INVENTION

This invention relates to a rear structure for an automobile comprising a cargo cover that divides a rear cargo compartment in a rear part of an automobile from a passenger compartment.

### BACKGROUND

It is known that a cargo cover (i.e. tonneau cover) that divides a rear cargo compartment in a rear part of an automobile from a passenger compartment. For example, Japanese Unexamined Patent Application Publication No. 2007-8339 discloses that a cargo cover has a mesh portion comprising reticulated through-holes passing through the cargo cover in a vertical direction.

For example, Japanese Unexamined Patent Application Publication No. 2008-87503 discloses a rear cargo floor board that can cover a storage space to open and close a storage recess provided on a floor of a rear cargo compartment. The rear cargo floor board is configured to function as a cargo cover by moving the rear cargo floor board upward from the floor of the rear cargo compartment. A mesh portion is provided on the rear cargo floor board.

For example, Japanese Unexamined Patent Application Publication No. 2006-96216 discloses an interior pressure release vent (i.e., extractor) provided in the rear portion of the automobile (i.e., in a rear cargo compartment). Through the interior pressure release vent, air inside of an automobile can be discharged to an outside of the automobile.

Recently, the number of SUVs (Sport Utility Vehicles) has increased. In such SUVs, dripping-wet personal effects (e.g. a dripping-wet swimming wear or dripping-wet marine sports equipment) are often loaded in a rear cargo compartment of the SUVs.

In order to dry out the dripping-wet personal effects quickly, it is effective to provide a mesh portion on the cargo cover and to put the dripping-wet personal effects on the mesh portion. Specifically, in the case where an interior pressure release vent is provided on the rear cargo compartment, air-conditioned air blown into a passenger compartment would flow through the mesh portion into the rear cargo compartment, and finally the air can be discharged through the interior pressure release vent to an outside of the automobile. As the air flows through the mesh portion, the dripping-wet personal effects put on the mesh portion can be dried out quickly.

However, in the case where the dripping-wet personal effects are put on the mesh portion, water drops from the dripping-wet personal effects may disadvantageously fall onto the floor of the rear cargo compartment (through the mesh portion), which may result in making the floor wet.

This invention is made so as to address this problem. A purpose of this invention is to prevent the floor of the rear cargo compartment from getting wet (due to the water drops from the dripping-wet personal effects), while drying out the dripping-wet personal effects quickly.

### SUMMARY

To achieve the above purpose, in accordance with an aspect of the invention, a rear structure for an automobile comprises an interior pressure release vent disposed in a rear cargo compartment in a rear part of the automobile, wherein the interior pressure release vent discharges air in a passenger compartment and the rear cargo compartment to an outside of the automobile; a cargo cover disposed above the rear cargo compartment so as to divide the rear cargo compartment from the passenger compartment, wherein the cargo cover has a mesh portion comprising reticulated through-holes passing through the cargo cover in a vertical direction; and a water receptor disposed below the mesh portion of the cargo cover and above a floor of the rear cargo compartment, wherein the water receptor is positioned to receive water drops from the dripping-wet personal effect(s) that are put on the mesh portion.

According to the above configuration, in the case where the dripping-wet personal effects are placed on the mesh portion (so as not to plug all the through-holes), the dripping-wet personal effects can be dried out quickly due to air flowing from the passenger compartment, through the mesh portion, and into the rear cargo compartment. In the meantime, although water drops from the dripping-wet personal effects may fall into the rear cargo compartment (through the mesh portion), the water receptor can receive the water drops before the water drops reach the floor of the rear cargo compartment. Therefore, it can prevent the floor of the rear cargo compartment from getting wet due to water drops from the dripping-wet personal effects.

In a preferable embodiment, the water receptor may be provided with an attachment for attaching the water receptor to the cargo cover.

In the case where the dripping-wet personal effects are put on the mesh portion, water drops from the dripping-wet personal effects may fall onto the water receptor. Accordingly, storing dry personal effects between the mesh portion and the water receptor may disadvantageously result in making the personal effects dripping-wet. If the water receptor is placed directly on the floor of the rear cargo compartment, a space between the mesh portion and the water receptor may become large. Thus, a remaining space in the rear cargo compartment for storing the dry personal effects without making them dripping-wet would become small. However, according to this embodiment (by attaching the water receptor to the cargo cover at an upper height in the rear cargo compartment), it is possible to ensure a large space for storing the dry personal effects without making them dripping-wet, even though the dripping-wet personal effects are put on the mesh portion.

In a preferable embodiment, the attachment may attach the water receptor to the cargo cover such that a gap is formed therebetween.

According to this embodiment, air can securely flow through the mesh portion, due to the gap between the cargo cover and the water receptor, in the case where the water receptor is attached to the cargo cover. Further, a flow velocity of the air flowing through the mesh portion can be increased by adjusting the dimension of the gap, which may advantageously result in drying the dripping-wet personal effects more quickly.

In a preferable embodiment, the water receptor may be selectively placed on the floor of the rear cargo compartment as a trunk box for storing the personal effects instead of being attached to the cargo cover by the attachment.

According to this embodiment, it is possible to use the water receptor as a trunk box that is placed on the floor of the rear cargo compartment, in the case where dripping-wet personal effects are not put on the mesh portion. This water receptor can store dripping-wet personal effects, as well as dry personal effects. Therefore, utility of the water receptor by occupants may be enhanced, because the water receptor can be used in various ways.

In a preferable embodiment, the water receptor may be supported on both left and right side walls of the rear cargo compartment, or a backside of a seat back of a seat that is disposed frontward of the rear cargo compartment.

According to this embodiment, a rigid support for supporting the water receptor that may contain much water can be enhanced as compared with that in the case of attaching the water receptor to the cargo cover. Further, a degree of freedom for supporting the water receptor at a desired height can be enhanced. Still further, particularly by disposing the water receptor close to the cargo cover, it is possible to ensure a large space for storing the dry personal effects without making them dripping-wet, in the case where the dripping-wet personal effects are put on the mesh portion.

In a preferable embodiment, the water receptor may be formed in a box shape with an opening on its upper side.

According to this embodiment, the water receptor can securely receive and store the water drops from the dripping-wet personal effects. Further, even though the water drops on the water receptor may move longitudinally or laterally due to force of inertia during accelerating/decelerating or curve traveling of the automobile, the box shape of the water receptor can prevent the water drops from spilling out of the water receptor. Still further, it can prevent the water drops from spilling out of the water receptor even when the automobile is parked on a longitudinally inclined road (e.g., up slope or down slope) or laterally inclined road (e.g., one-way grade).

In a preferable embodiment, the water receptor may be disposed so as to overlap with a whole area of the mesh portion in a top view.

According to this embodiment, the dripping-wet personal effects can be put anywhere on the mesh portion, and the water receptor may certainly be below the dripping-wet personal effects. Therefore, this embodiment can securely prevent the floor of the rear cargo compartment from getting dripping-wet due to water drops from the dripping-wet personal effects.

As described above, according to the invention, the rear structure for the automobile comprises an interior pressure release vent disposed in a rear cargo compartment in a rear part of the automobile; a cargo cover having a mesh portion; and a water receptor disposed below the mesh portion of the cargo cover and above the floor of the rear cargo compartment, wherein the water receptor is positioned to receive water drops from the dripping-wet personal effect that are put on the mesh portion. Therefore, it can prevent the floor of the rear cargo compartment from getting dripping-wet due to water drops from the dripping-wet personal effects, while quickly drying out the dripping-wet personal effects.

### BRIEF DESCRIPTION OF THE DRAWINGS

FIG. 1 is a schematic cross-sectional view showing a rear part of an automobile to which a rear structure according to Embodiment 1 of the present invention is applied.

FIG. 2 is an exploded perspective view showing a configuration of a vehicle body and trim panels in the rear part of the automobile.

FIG. 3 is a perspective view showing the rear part of the automobile.

FIG. 4 is an exploded perspective view showing a configuration of a cargo cover and a water receptor.

FIG. 5 is a cross-sectional perspective view showing a configuration in the vicinity of a hinge when a lid member is in an open state.

FIG. 6 is a cross-sectional view taken along a line VI-VI of FIG. 4.

FIG. 7 is a cross-sectional view showing a modification of the cargo cover.

FIG. 8 is a schematic cross-sectional view showing a rear part of an automobile to which a rear structure according to Embodiment 2 of the present invention is applied.

FIG. 9 is a perspective view showing a rear part of an automobile according to Embodiment 2.

FIG. 10 is a perspective view showing a cargo cover according to Embodiment 2.

FIG. 11 is a cross-sectional view taken along a line XI-XI of FIG. 9.

FIG. 12 is a schematic cross-sectional view showing a rear part of an automobile to which a rear structure according to Embodiment 3 of the present invention is applied.

FIG. 13 is an exploded perspective view showing a rear part of an automobile according to Embodiment 3.

FIG. 14 is a cross-sectional view taken along a vertical plane formed along the dash dot line intersecting a central support member in a rear seat back of the automobile of FIG. 13.

### DETAILED DESCRIPTION

Hereafter, embodiments of the present invention will be explained in detail based on the appended drawings. The description of the following embodiments is essentially only illustration, and does not intend to limit the present invention, its applications, or its use.

### Embodiment 1

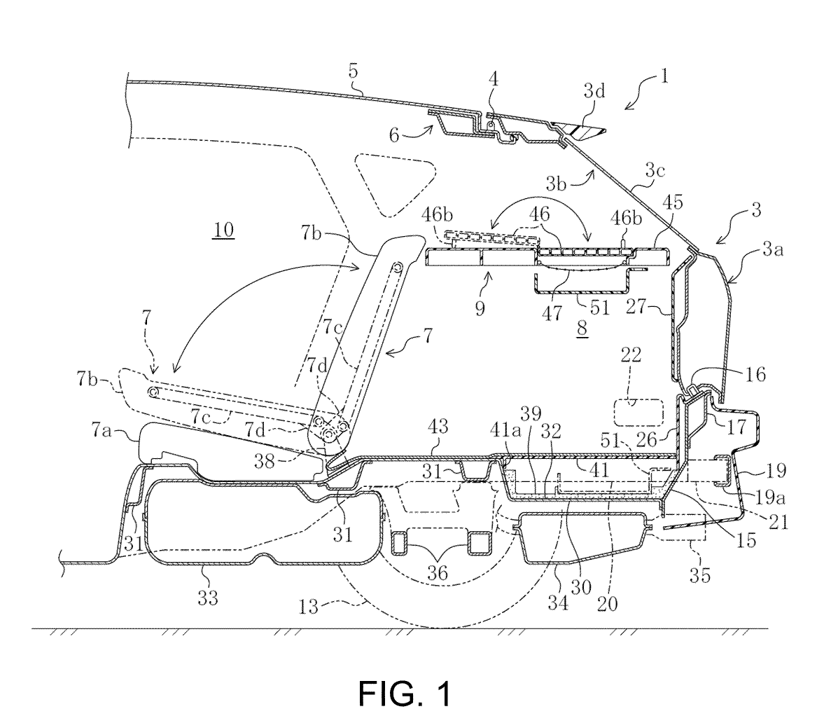

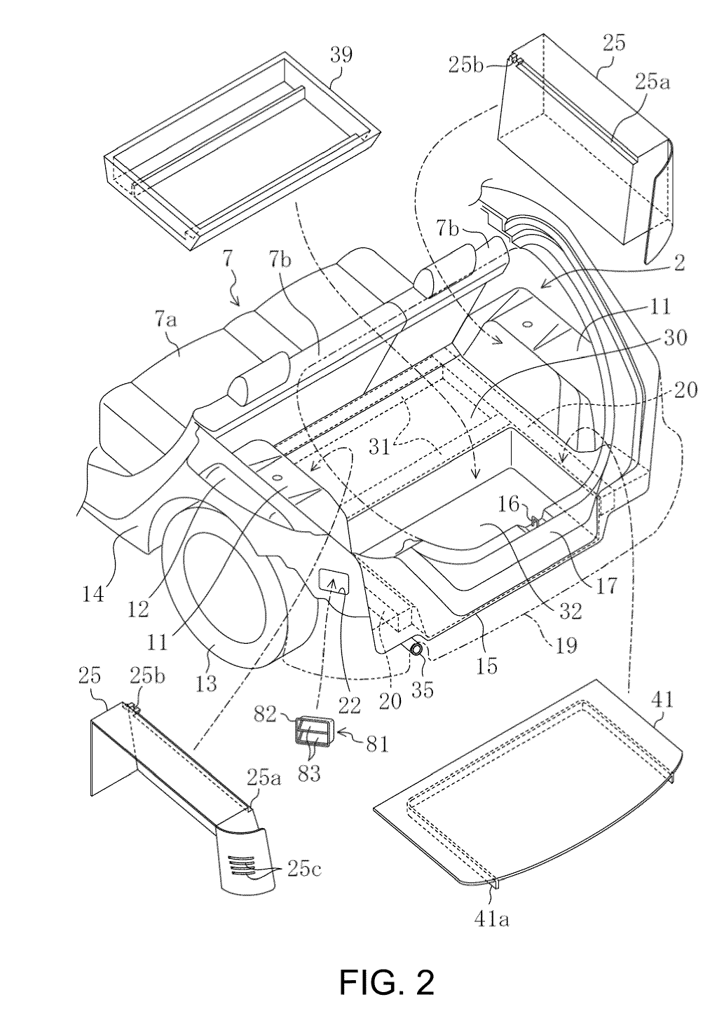

FIG. 1 shows a rear part of an automobile 1 to which a rear structure according to Embodiment 1 of the present invention is applied. This automobile 1 is of a hatchback type and is provided with a liftgate 3 for closing an opening part 2 (refer to FIG. 2) in a rear face of the automobile 1. The liftgate 3 is supported at its upper end part so as to be rotatable around a hinge shaft 4. The hinge shaft 4 is provided in a part corresponding to a rear end part of a rear header 6 in a rear end part of a roof panel 5. Thus, the liftgate 3 opens and closes the opening part 2 by rotating around the hinge shaft 4. The liftgate 3 includes a body part 3a having a window opening 3b in its upper part, a window glass 3c provided over the window opening 3b, and a rear spoiler 3d provided in an upper edge of the window opening 3b. The automobile 1 to which the present invention is applied is not limited to the hatchback type described above, and may be of any other type, as long as the automobile 1 is provided with a rear cargo compartment as described later. Note that, the terms used herein, “front,” “rear,” “left,” and “right” refer to the front, rear, left, and right of the automobile 1, respectively.

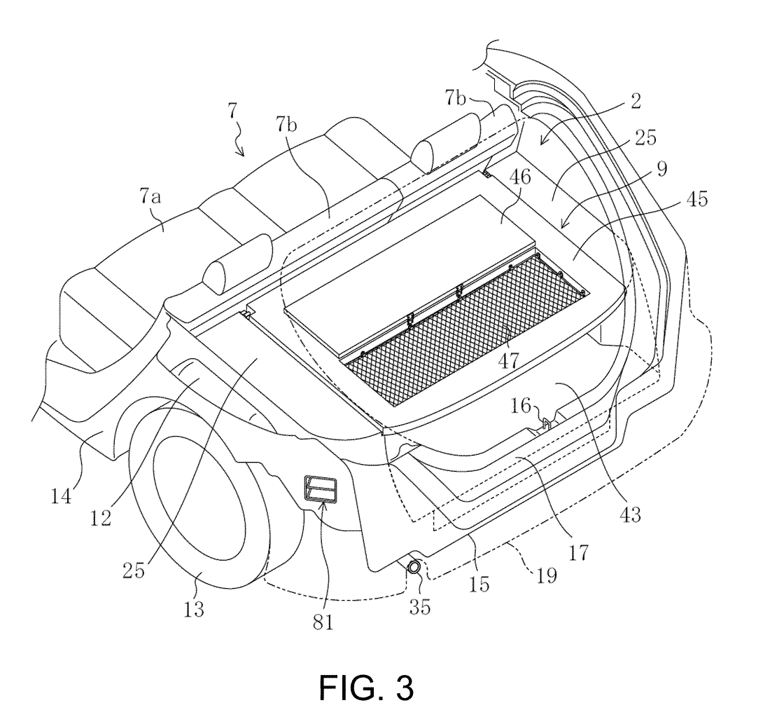

The rear cargo compartment 8 is arranged behind a rear seat 7 in a rear part of the automobile 1. By opening the liftgate 3, the rear cargo compartment 8 is opened rearwardly via the opening part 2, and becomes possible to load and unload articles to/from the rear cargo compartment 8 through the opening part 2. A cargo cover 9 (refer to FIGS. 1 and 3) for dividing the rear cargo compartment 8 and a passenger compartment 10 is arranged above the rear cargo compartment 8. Both left and right ends of the cargo cover 9 are placed on step parts 25a (refer to FIGS. 2 and 3) formed in an upper part of left and right cargo compartment side trim panels 25 described below, respectively.

As shown in FIG. 2, side walls on both the left and right sides of the rear cargo compartment 8 includes left and right inner wheel well panels 11 (including the cargo compartment side trim panel 25, described later), respectively. Each inner wheel well panel 11 constitutes a wheel well of a rear wheel 13 along with an outer wheel well panel 12 arranged on the outside therefrom in the vehicle width direction. The outside of each outer wheel well panel 12 in the vehicle width direction is covered by an exterior side panel 14 that constitutes a body side part of the automobile 1, and a part of the exterior side panel 14 corresponding to the wheel well and a lower end part of the outer wheel well panel 12 are coupled to each other.

A lower part of a rear wall of the rear cargo compartment 8 is constituted with a rear cargo inner panel 15 (refer to FIGS. 1 and 2). An upper end of the rear cargo inner panel 15 serves as a lower edge of the opening part 2, and has a latch striker 16 that engages with a latch mechanism (not illustrated) provided in a lower end part of the body part 3a of the liftgate 3. An upper end of the rear cargo inner panel 15 and its vicinity part are reinforced by a rear cargo outer panel 17. An upper part of a rear wall of the rear cargo compartment 8 is constituted with a part of the body part 3a of the liftgate 3, which is below the window opening 3b.

A rear bumper 19 is arranged behind the rear cargo inner panel 15. A reinforcement 19a (shown only in FIG. 1) of the rear bumper 19 is fixed to the left and right rear side frames 20 (refer to FIGS. 1 and 2) via bumper crash beams 21 (shown only in FIG. 1) provided in rear ends of the rear side frame rails 20, respectively.

In a lower part of the rear end part of the left exterior side panel 14 (a part covered with a left end part of the rear bumper 19, a vent hole 22 of an extractor (refer to FIGS. 1 and 2), to which an interior pressure release vent (i.e., the extractor) 81 (refer to FIGS. 2 and 3) is attached, is formed. The extractor discharges air from inside the passenger compartment 10 and the rear cargo compartment 8 to outside of the automobile. The vent hole 22 communicates with the rear cargo compartment 8 and, thus, the extractor 81 is arranged in the rear cargo compartment 8. As shown in FIG. 2, the extractor 81 includes a frame-shaped member 82 made of a resin to be fitted into the vent hole 22, and a cutoff valve 83 constituted with a flexible sheet member, which is attached to the frame-shaped member 82 so as to cover an opening corresponding to an inner part of the frame-shaped member 82. The cutoff valve 83 is configured to be in a one-way structure (check valve) that allows discharge of air from inside of the automobile to outside of the automobile through the opening of the frame-shaped member 82 and the vent hole 22, while inhibiting a flow of air from outside of the automobile into the automobile.

As shown in FIG. 2, the cargo compartment side trim panel 25 for covering the inner wheel well panel 11 is attached to the inside of each inner wheel well panel 11 in the vehicle width direction (on the side of the rear cargo compartment 8). Although the left cargo compartment side trim panel 25 covers the vent hole 22, a part thereof opposite to the vent hole 22 (the extractor 81) is formed with two or more slit holes 25c for ventilation to allow an air flow from the rear cargo compartment 8 to the vent hole 22 (the extractor 81). A rear cargo area back trim panel 26 (refer to FIG. 1), which covers the rear cargo inner panel 15, is attached to the front side of the rear cargo inner panel 15 (on the side of the rear cargo compartment 8). Referring to FIG. 1, to the front side (on the side of the rear cargo compartment 8) of a part of the body part 3a of the liftgate 3 below the window opening 3b, a liftgate trim panel 27 that covers a part of the liftgate 3 is attached. Note that, in FIG. 2, illustration of the liftgate 3, the cargo cover 9, and a rear cargo floor carpet 43, described later, are omitted.

Turning now to FIG. 2, a rear cargo floor panel 30 that constitutes a rear cargo floor of the rear cargo compartment 8 is fixed to an upper face of the left and right rear side frame rails 20. Cross members 31 extending in the vehicle width direction are fixed to parts corresponding to a front end part and a lower end part of the rear seat 7, and a central part of the rear cargo compartment 8 in the front-and-rear direction, respectively, in a lower face of the rear cargo floor panel 30. Both ends of the cross members 31 are fixed to the left and right rear side frame rails 20. A part of the rear end part of the rear cargo floor panel 30, surrounded by the left and right rear side frame rails 20 and the rearmost cross member 31 is concaved downwardly, and constitutes a rear cargo floor panel 32 of substantially a rectangular shape in a top view along with the rear cargo inner panel 15. Note that the floor panel 30 does not need to be constituted with a single plate member and may be constituted with two or more plate members. Particularly, the part that constitutes the rear cargo floor panel 32 may be constituted with a plate member that is different from other parts.

Referring to FIG. 1, a fuel tank 33 having a structure in which it is divided vertically into two is arranged in a part corresponding to the rear seat 7 below the rear cargo floor panel 30, and a silencer 34 having a structure in which it is divided vertically into two provided in a rear part of an exhaust pipe is arranged in a part corresponding to the rear cargo floor panel 32. A tail pipe 35 of the exhaust pipe is connected to the silencer 34. In a part between the fuel tank 33 and the silencer 34 below the rear cargo floor panel 30, two subframes 36 for supporting a non-illustrated rear wheel suspension (E-type multi-link suspension) are arranged tandem in a state where they extend in the vehicle width direction. Both ends of the subframes 36 are fastened and fixed to the left and right rear side frame rails 20 with bolts, respectively.

The rear seat 7 has a seat cushion 7a fixed onto an upper face of the rear cargo floor panel 30, and two seat backs (one seat back 7b is shown) provided so as to be arranged in the vehicle width direction behind the seat cushion 7a. Each seat back 7b is rotatably supported by support brackets 38 provided behind the seat cushion 7a on the upper face of the rear cargo floor panel 30 and on both left and right sides of each seat back 7b. That is, a support member 7d fixed to a lower part of both left-and-right-side side parts of a seat back frame 7c (shown by two dot chain lines inside unfolded seat back 7b) provided over the entire periphery part inside each seat back 7b is rotatably coupled to an upper end part of the left and right support brackets 38. In an in-use state (unfolded state) of the rear seat 7, the seat backs 7b are in a state where they stand up so as to extend in the vertical direction. By folding the seat back 7b forward to the seat cushion 7a so as to contact a back face of the seat back 7b with a seating face of the seat cushion 7a, the rear seat 7 can be switched from the unfolded state to a folded state (seat back 7b and seat back frame 7c are shown in the folded state by two dot chain lines in FIG. 1).

A sub-trunk insert 39 (refer to FIGS. 1 and 2) made of a foamed styrene is fixed to a bottom face inside the rear cargo floor panel 32. A rear part of the sub-trunk insert 39 is formed in a shape to which a water receptor 51 described below can be set.

An upper opening of the rear cargo floor panel 32 is closed by a sub-trunk cover 41 (refer to FIGS. 1 and 2) made of a resin (for example, polypropylene). A positioning projecting part 41a (refer to FIG. 2), for positioning the sub-trunk cover 41 by contacting with an upper end part of the front side of the rear cargo floor panel 32 and both the left and right sides of the rear cargo floor panel 32, is formed on a lower face of the sub-trunk cover 41. The sub-trunk cover 41 is simply placed on the upper side of the rear cargo floor panel 32, and therefore, an operator of the automobile 1 removes the sub-trunk cover 41 to release the opening of the rear cargo floor panel 32 so that the operator can load and unload articles to/from the rear cargo floor panel 32.

The rear cargo floor carpet 43 (refer to FIG. 1 and FIG. 3) is laid on an upper face of the rear cargo floor panel 30 in the rear cargo compartment 8. The rear cargo floor carpet 43 also covers the upper side of the sub-trunk cover 41, and thereby, the rear cargo floor carpet 43 spreads over the entire floor of the rear cargo compartment 8 to improve the appearance of the floor. In this embodiment, an upper face of the rear cargo floor carpet 43 substantially serves as the floor of the rear cargo compartment 8. Note that, as shown in FIG. 1, a front end part of the rear cargo floor carpet 43 is, in its slack state, fixed to a lower part of the rear face of each seat back 7b of the rear seat 7 in the unfolded state. When the rear seat 7 is switched to the folded state, the front end part of the rear cargo floor carpet 43 will be in a state where it is not slackened and is evenly spread.

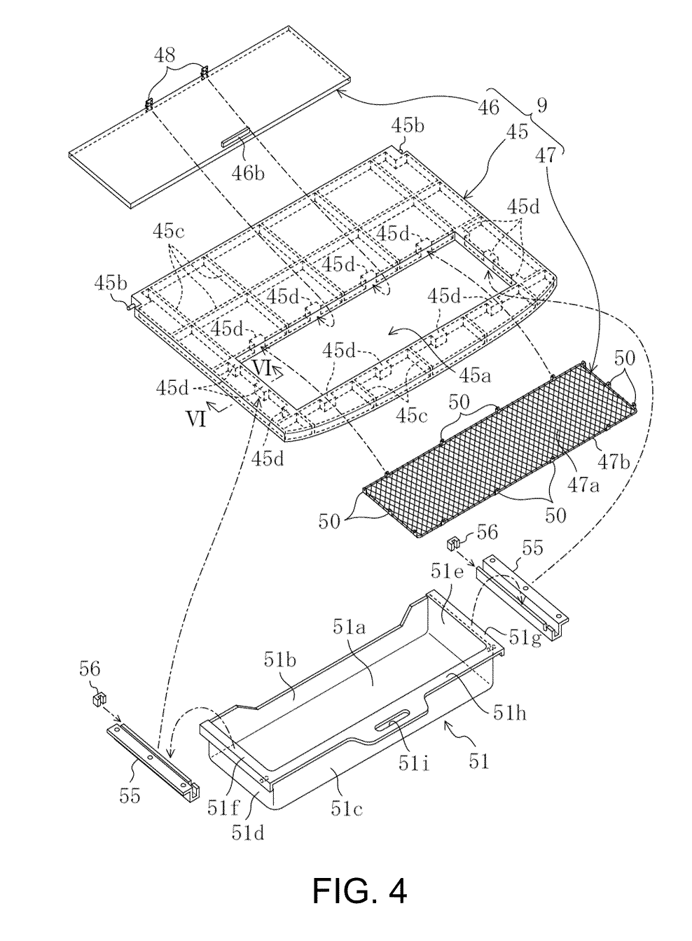

As shown in FIG. 4, the cargo cover 9 includes a cargo cover main part 45 made of a resin (for example, polypropylene), a rear part of which is formed with a rectangular hole 45a penetrating vertically, a lid member 46 made of a resin (for example, polypropylene) covering so as to open and close the upper side of the rectangular hole 45a, and a net member 47 bridged over the entire rectangular hole 45a. The net member 47 corresponds to a mesh part having a meshed through-hole penetrating in the vertical direction.

A front end part of the cargo cover main part 45 is shorter than other parts in the left-and-right direction, and hinge shafts 45b are formed so as to project from both left and right end faces of the front end part, respectively. Both of the hinge shafts 45b are fitted into and engaged with bearing parts 25b (FIG. 2) provided in a front end part of the step parts 25a in both the left and right cargo compartment side trim panels 25. Thereby, the cargo cover main part 45 (as a result, the entire cargo cover 9) is rotatable around the hinge shafts 45b. When the liftgate 3 is closed, the cargo cover 9 covers the upper part of the rear cargo compartment 8 so as to extend horizontally and, thus, divides the rear cargo compartment 8 and the passenger compartment 10 (which is, in detail, a part which is an upper part of the passenger compartment 10 and extends rearwardly from the rear seat). On the other hand, when the liftgate 3 is opened, the cargo cover 9 is rotated around the hinge shafts 45b, and is then lifted via a non-illustrated interlocking member. Thereby, the loading and unloading of articles to/from the rear cargo compartment 8 will be easy.

A thickness of the cargo cover main part 45 is relatively thin, and in order to increase its strength, many reinforcement ribs 45c are formed on a lower face of the cargo cover main part 45 so as to be in a lattice shape. Two or more thickened parts 45d (refer to FIGS. 4 to 6) are formed in an edge part of the rectangular hole 45a in the cargo cover main part 45 so as to be spaced by predetermined intervals in the circumferential direction.

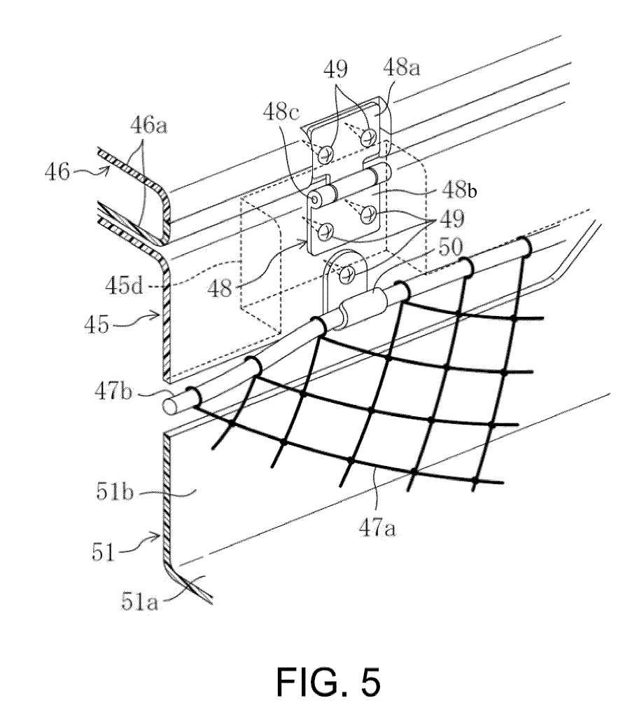

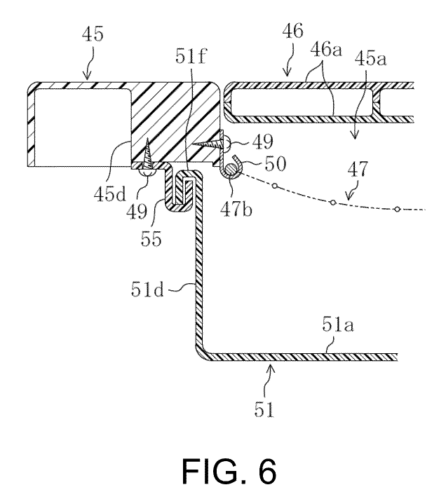

The lid member 46 is formed by piling up two plate members 46a in the vertical direction (refer to FIGS. 5 and 6). As shown in FIG. 4, hinge members 48 are attached and fixed to a front end face of the lid member 46 (at two places). As shown in detail in FIG. 5, each hinge member 48 has two rotating pieces 48a and 48b configured so as to be rotatable relative to each other around a rotating shaft 48c. One rotating piece 48a is attached and fixed to a front end part of the lid member 46 with tapping screws 49 (in FIG. 5, the lid member 46 is in an open state described later, and in this open state, this would be a rear end part of the lid member 46 such that the rotating piece 48a is attached to a rear end part of the lid member), and the other rotating piece 48b is attached and fixed to the thickened part 45d provided in a front edge part of the rectangular hole 45a in the cargo cover main part 45 with tapping screws 49. By the two hinge members 48, the lid member 46 is rotatable counterclockwise in FIG. 1 around the rotating shafts 48c from the closed state in which the upper side of the rectangular hole 45a is covered, and, finally, an upper face of the lid member 46 (in detail, a knob part 46b described later) contacts a front part of the upper face of the cargo cover main part 45. In this way, an open state can be attained in which the rectangular hole 45a is opened (refer to two dot chain lines in FIG. 1, and also shown in an open state in FIGS. 3 and 5). The knob part 46b for lifting and rotating the lid member 46 is formed so as to project from the rear end part of the upper face of the lid member 46 in the closed state.

The net member 47 includes a net mesh 47a knitted in a mesh shape, and a net outer frame cord 47b for supporting the net mesh 47a. The net outer frame cord 47b is suspended from hangers 50 attached and fixed to each thickened part 45d with the tapping screws 49.

If the lid member 46 is switched into the open state, it is possible to place an article on the net member 47, and particularly, when a dripping-wet article (swimwear, a marine sports article, etc.) is placed thereon, drying out of the dripping-wet article can be facilitated. That is, air-conditioning air blown out to the passenger compartment 10 passes through an air channel formed in the sides of the rear seat 7 between the net member 47 and the passenger compartment 10, and the rear cargo compartment 8, the air then flows into the rear cargo compartment 8, and is then discharged from the rear cargo compartment 8 to outside of the automobile via the extractor 81. Thus, because air flows through the net member 47, the dripping-wet article placed on the net member 47 can be dried out quickly by the air flow. The size of the meshes of the net member 47 may be set considering the quick drying capability for such a dripping-wet article and the size of the dripping-wet article.

The net mesh 47a of the net member 47 may preferably be made from a material having elasticity. As such, when the dripping-wet article is placed on the net member 47, the net mesh 47a is stretched downwardly by the weight of the dripping-wet article, and, thereby, the air flow easily contacts a large area of the dripping-wet article.

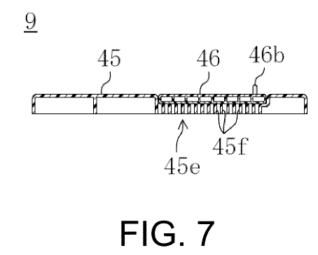

Note that, as shown in FIG. 7, instead of the rectangular hole 45a, a mesh part 45e having through-holes 45f (slit holes) of a mesh shape penetrating in the vertical direction may be formed in a part of the cargo cover main part 45 where the rectangular hole 45a is formed, and the net member 47 may be omitted. The mesh part 45e serves similarly to the net member 47, and when the dripping-wet article is placed on the mesh part 45e of the cargo cover main part 45, the dripping-wet article can be dried out quickly. The shape and the size of the through-holes 45f (meshes) may be appropriately set considering the quick drying capability for the dripping-wet article and the size of the dripping-wet article, similar to the meshes of the net member 47.

When the dripping-wet article is placed on the net member 47, water drops from the dripping-wet article can pass through the net member 47. In this embodiment, in order to prevent the floor (the rear cargo floor carpet 43) of the rear cargo compartment 8 from getting dripping-wet by the water drops, the water receptor 51 made of a resin (for example, polypropylene), that receives water drops which fall through the net member 47 from the dripping-wet article placed on the net member 47, is arranged below the net member 47 and above the floor of the rear cargo compartment 8.

The water receptor 51 is formed in a rectangular box shape having an opening on its upper side. That is, the water receptor 51 is constituted with a bottom wall part 51a of a rectangular shape extending horizontally, and a front-side side wall part 51b, a rear-side side wall part 51c, a left-side side wall part 51d, and a right-side side wall part 51e that rise substantially perpendicularly with respect to the bottom wall part 51a from the entire periphery of the bottom wall part 51a. Waterproofing is given to inner faces of each wall parts 51a-51e, and thereby, the water receptor 51 can catch the water drops which fall from above.

The water receptor 51 is configured to be selectively switchable between a state where it is attached to the cargo cover main part 45 of the cargo cover 9 (the state shown in FIG. 1 by solid lines) and a state where it is set upon the sub-trunk insert 39 in the rear cargo floor panel 32 (the state shown in FIG. 1 by two dot chain lines). When the dripping-wet article is not placed on the net member 47, the water receptor 51 is set to the sub-trunk insert 39 to be used as a trunk box or storage box in which an article(s) is accommodated (it may be the dripping-wet article(s)).

Attachment members 51f and 51g are formed integrally in the water receptor 51 to attach the water receptor 51 to the cargo cover main part 45 of the cargo cover 9. That is, the left attachment member 51f and the right attachment member 51g which bend downwardly after projecting horizontally to the left and right are formed integrally with the water receptor 51 at the upper ends of the left-side side wall part 51d and the right-side side wall part 51e, respectively. These left and right attachment members 51f and 51g engage with a pair of the rail members 55 provided so as to extend in the front-and-rear direction at both left and right sides of the rectangular hole 45a on the lower face of the cargo cover main part 45, respectively, and are slidable in the lengthwise direction of the rail members 55 (front-and-rear direction) (refer to FIGS. 4 and 6). The left rail member 55 is attached and fixed to the above-described three thickened parts 45d located in a left edge part of the rectangular hole 45a by tapping screws 49, and the right rail member 55 is attached and fixed to the three thickened parts 45d located in a right edge part of the rectangular hole 45a by tapping screws 49.

When attaching the water receptor 51 to the cargo cover 9 (the cargo cover main part 45), the left and right attachment members 51f and 51g are brought to engage with both the rail members 55 from the rear, respectively, and both the attachment members 51f and 51g (the water receptor 51) are slid forward on both the rail members 55, respectively. Then, when the water receptor 51 reaches a position overlapping with the entire area of the net member 47 as seen from above, the front ends of both the attachment members 51f and 51g contact stoppers 56 (refer to FIG. 4) provided in the front end parts of both the rail members to prevent both the attachment members 51f and 51g from moving forward, and thereby, the attachment of the water receptor 51 to the cargo cover 9 is completed.

On the other hand, when removing the water receptor 51 from the cargo cover 9, contrary to the attaching procedure described above, both the attachment members 51f and 51g (the water receptor 51) are moved rearwardly on both the rail members 55. A projecting part 51h projecting horizontally to the rear is formed at the upper end of the rear-side side wall part 51c of the water receptor 51. A finger-hooking hole 51i is formed in a central part of the projecting part 51h in the left-and-right direction to allow an operator to hook his/her fingers thereon and move the water receptor 51 rearwardly with respect to the cargo cover 9.

In a state where the water receptor 51 is attached to the cargo cover 9, gaps are formed between a lower face of the cargo cover main part 45 and the upper end of the front-side side wall part 51b, and between the lower face of the cargo cover main part 45, and the upper end of the rear-side side wall part 51c and the upper face of the projecting part 51h, respectively. Particularly, a height of an intermediate part in the left-and-right direction of the upper end of the front-side side wall part 51b is set low, and a gap between the lower face of the cargo cover main part 45 is set large. As a result, the air in the passenger compartment passes through the net member 47, and after that, it passes at least one of both the gaps, and then flows into the rear cargo compartment 8. Therefore, even if the water receptor 51 is attached to the cargo cover 9, the water receptor 51 does not interrupt the air flow, and thereby the drying out of the dripping-wet article can still be stimulated.

One of the gaps may be eliminated. However, because air flows eccentrically to the front or to the rear where the gap is located, eliminating one of the gaps may cause the dripping-wet article not to be dried out uniformly. Therefore, it may be preferred to form gaps at both front and rear, as described above, to uniformly dry out the dripping-wet article. Alternatively, air communicating holes may more preferably be formed in the vicinity of the upper end of the left-side and right-side side wall parts 51d and 51e so that air flows to the left and to the right, as well as to the front and to the rear. Alternatively or additionally, instead of both the gaps, the air communicating holes may be formed in the vicinity of the upper ends of the front-side and rear-side side wall parts 51b and 51c.

Therefore, in this embodiment, because the net member 47 is provided to the cargo cover 9, quick drying out of the dripping-wet article can be achieved by the air flow caused by the extractor 81 by placing the dripping-wet article on the net member 47. In addition, attaching the water receptor 51 to the lower face of the cargo cover main part 45 before placing the dripping-wet article on the net member 47 can prevent the floor of the rear cargo compartment 8 (the rear cargo floor carpet 43) from getting wet by water drops fallen from the dripping-wet article.

Because the water receptor 51 is attached to the lower face of the cargo cover main part 45, normal article(s) which are not dripping-wet can be placed in a space between the water receptor 51 and the floor of the rear cargo compartment 8. As a result, a large space for accommodating the normal article(s) can be secured when the dripping-wet article is placed on the net member 47.

### Embodiment 2

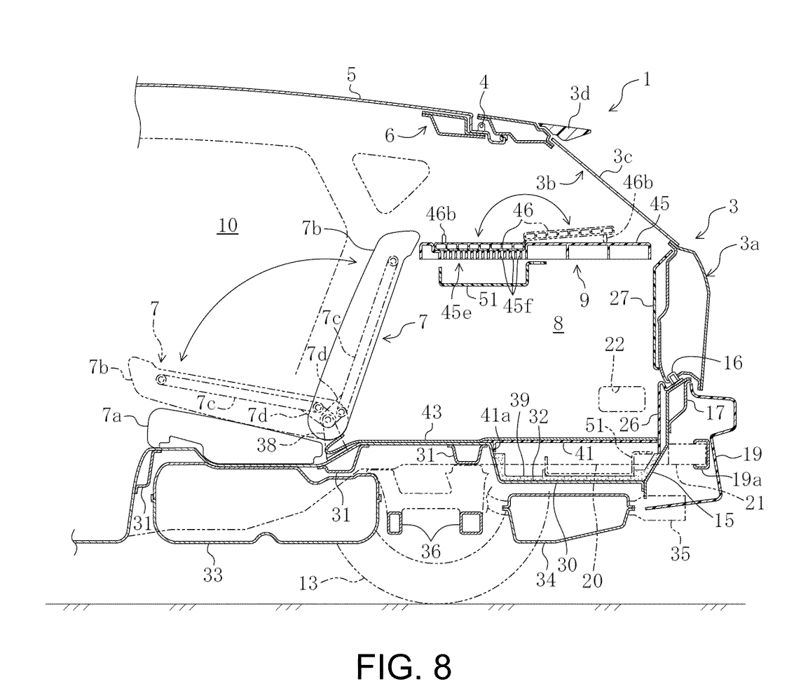

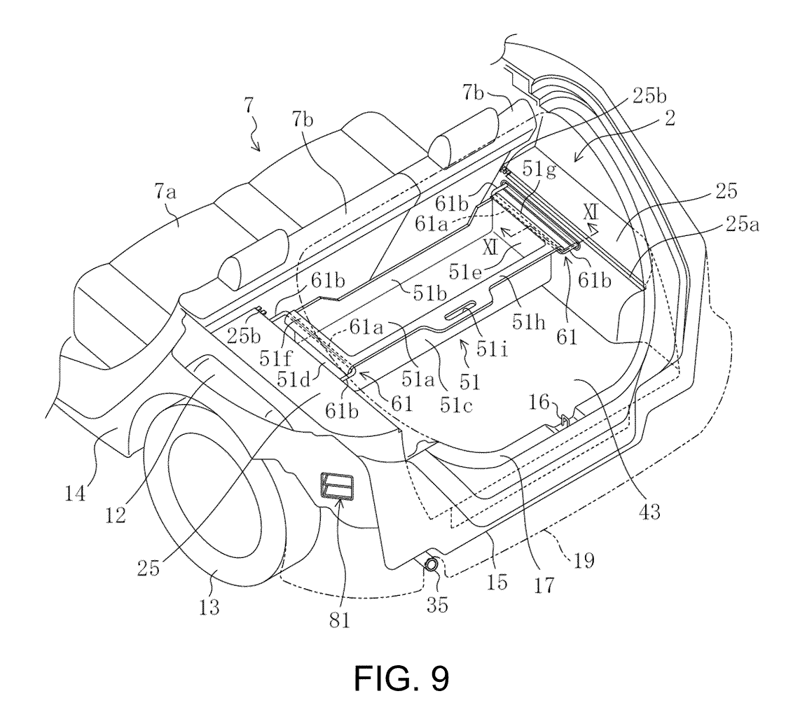

FIGS. 8 to 11 show Embodiment 2 of the present invention, and this embodiment is configured so that the water receptor 51 is supported by the both left-side and right-side side walls (the cargo compartment side trim panel 25) of the rear cargo compartment 8. Note that, in FIG. 9, illustration of the liftgate 3 and the cargo cover 9 is omitted.

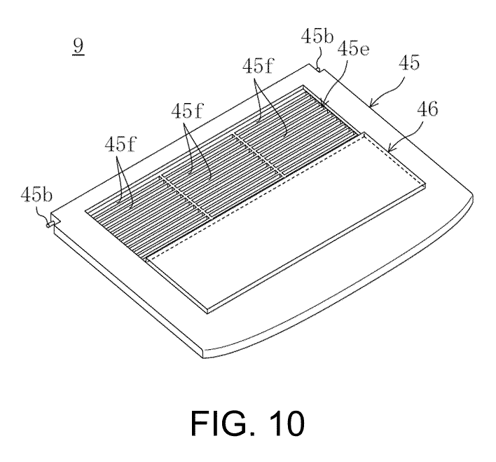

More particularly, in this embodiment, as similar to what is illustrated in FIG. 7, a mesh part 45e having through-holes 45f (slit holes) of a mesh shape penetrating in the vertical direction is formed in the cargo cover main part 45 of the cargo cover 9, but the net member 47 does not exist in this embodiment. A mesh part 45e is formed in a front part of the cargo cover 9, and the lid member 46 covers the mesh part from above. This lid member 46 has a similar configuration to that of Embodiment 1. However, the front part and rear part of lid member 46 are reversed from the configuration of Embodiment 1. The lid member 46 is rotated clockwise around the rotating shafts 48c (illustration is omitted in FIG. 8) of the hinge members 48 provided on a rear end face of the lid member 46, from a closed state in which the lid member 46 covers the upper side of the mesh part 45e, so that an upper face of the lid member 46 (in detail, the knob part 46b) contacts a rear part of the upper face of the cargo cover main part 45. In this way, the lid member 46 becomes in an open state in which the mesh part 45e is opened (refer to two dot chain lines of FIG. 8, and FIG. 10).

Thus, after the lid member 46 is switched into the open state, the dripping-wet article is placed on the mesh part 45e (however, all the through-holes should not be closed by the dripping-wet article). Thereby, drying out of the dripping-wet article can be stimulated by the air flow which passes through the through-holes 45f of the mesh part 45e from the sides of the passenger compartment 10 to the sides of the rear cargo compartment 8, and is then discharged to outside of the automobile via the extractor 81.

The water receptor 51 is arranged below the mesh part 45e and above the floor of the rear cargo compartment 8. In this embodiment, the water receptor 51 is not attached to the cargo cover 9, but is attached to a support member 61 provided in a front upper part of the left and right cargo compartment side trim panels 25, respectively.

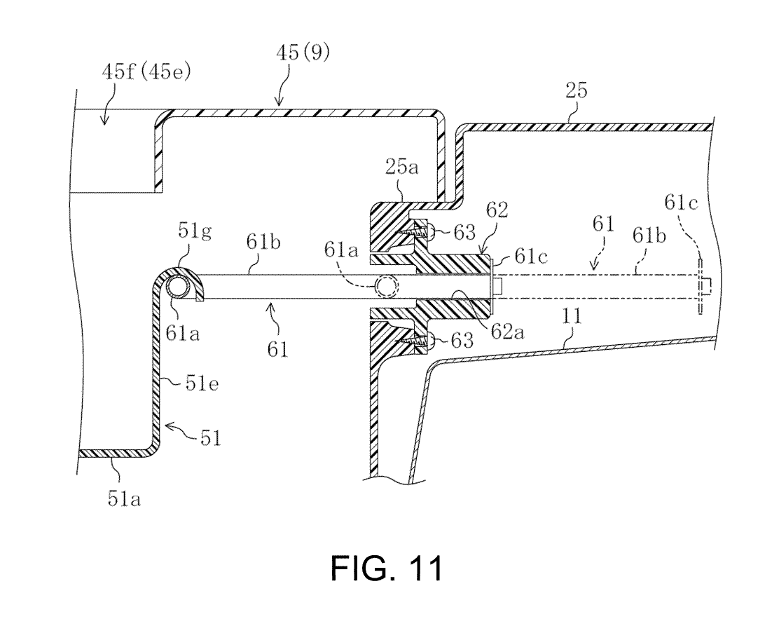

Each support member 61 includes a support part 61a which is a bent bar member of a circular cross-section and extends in the front-and-rear direction, and two slide parts 61b extending in the horizontal direction (in the vehicle width direction) on both sides of the support part 61a. As shown in FIG. 11, each slide part 61b is inserted in a guide hole 62a of a guide member 62 attached and fixed to the cargo compartment side trim panel 25 with tapping screws 63, and is supported slidably in the horizontal direction with respect to the guide hole 62a. Thereby, it is possible to selectively switch each support member 61 between a state where it projects from the cargo compartment side trim panel 25 to the rear cargo compartment 8 and a state where it is evacuated from the rear cargo compartment 8. A stopper part 61c having a larger diameter than the guide hole 62a is provided at the opposite end of the slide part 61b from the support part 61a so that an operator pulls out the support member 61 until the stopper part 61c contacts an end face of the guide member 62 from the evacuated state to switch it into the projected state.

Similar to Embodiment 1, the water receptor 51 is formed in a rectangular box shape having an opening in the upper part, and includes the bottom wall part 51a, as well as the front-side side wall part 51b, the rear-side side wall part 51c, the left-side side wall part 51d, and the right-side side wall part 51e which rise substantially perpendicularly with respect to the bottom wall part 51a from the entire periphery of the bottom wall part 51a.

The left attachment member 51f and the right attachment member 51g similar to those of Embodiment 1 are provided integrally at the upper end of the left-side side wall part 51d and the right-side side wall part 51e of the water receptor 51, respectively. In this embodiment, as shown in FIG. 11, because the attachment members 51f and 51g are bent in an inverted U-shape, they can hook on the support parts 61a of the left and right support members 61, respectively. By hooking the left and right attachment members 51f and 51g on the support parts 61a of the support members 61, respectively, the water receptor 51 is supported below the mesh part 45e and above the floor of the rear cargo compartment 8 (in this embodiment, a height close to the mesh part 45e). In this supported state, the water receptor 51 overlaps with the entire area of the mesh part 45e when seen from above.

The height position of the water receptor 51 supported by the support member 61 may be any height position, without limiting to the height position close to the mesh part 45e, as long as it is below the mesh part 45e and above the floor of the rear cargo compartment 8. However, when placing the dripping-wet article on the mesh part 45e, because water drops fall from the mesh part 45e, it may not be possible to place the normal article(s), which is not dripping-wet, between the water receptor 51 and the mesh part 45e. Therefore, it may be preferred to bring the water receptor 51 closer to the mesh part 45e as much as possible in order to secure the space for accommodating the normal article(s) (this is similar for Embodiment 3, described later).

Similar to Embodiment 1, the projecting part 51h is formed at the upper end of the rear-side side wall part 51c of the water receptor 51, and the finger-hooking hole 51i is formed in a central part of the projecting part 51h in the horizontal direction. The operator hooks his/her fingers on the finger-hooking hole 51i and lifts the rear end part of the water receptor 51 to release the attachment members 51f and 51g from the support parts 61a of the left and right support members 61.

The water receptor 51 removed from the support member 61 in this way may be used, similar to Embodiment 1, as a trunk box (i.e., storage box) that is set to the sub-trunk insert 39 in the rear cargo floor panel 32 and in which article(s) (which may be the dripping-wet article(s)) is accommodated. At this time, if each support member 61 is switched into the evacuated state, each support member 61 will not be obstructive when accommodating the article into the rear cargo compartment 8.

Therefore, also in this embodiment, similar to Embodiment 1, it can stimulate drying out of the dripping-wet article, while preventing the floor of the rear cargo compartment 8 from getting wet by water drops fallen from the dripping-wet article. In addition, because the water receptor 51 is supported by both the left-side and right-side side walls (the cargo compartment side trim panels 25) of the rear cargo compartment 8, the supporting capability of the water receptor 51 when the water receptor becomes heavy with a lot of water can be improved compared with the case where the water receptor 51 is attached to the cargo cover 9 (e.g., Embodiment 1).

### Embodiment 3

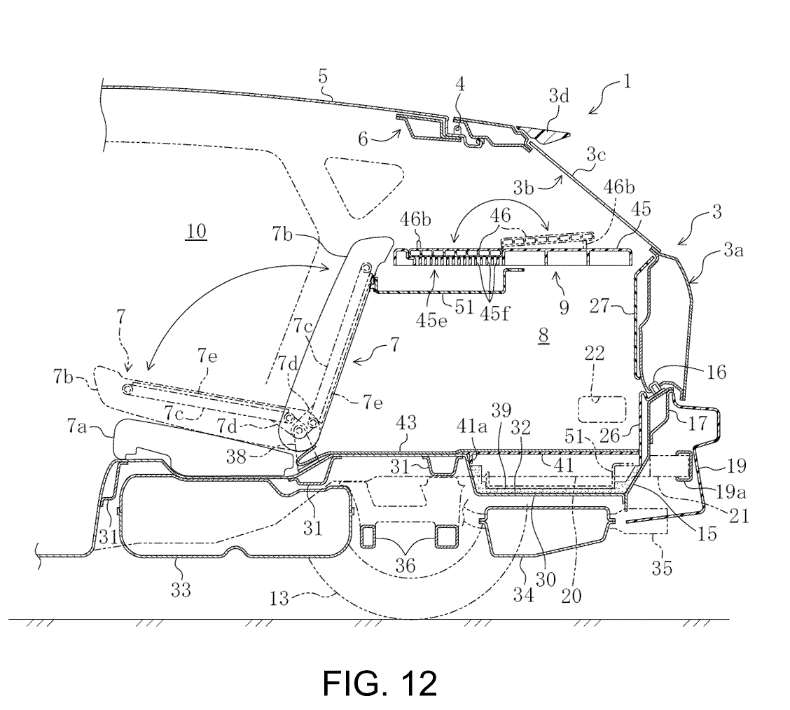

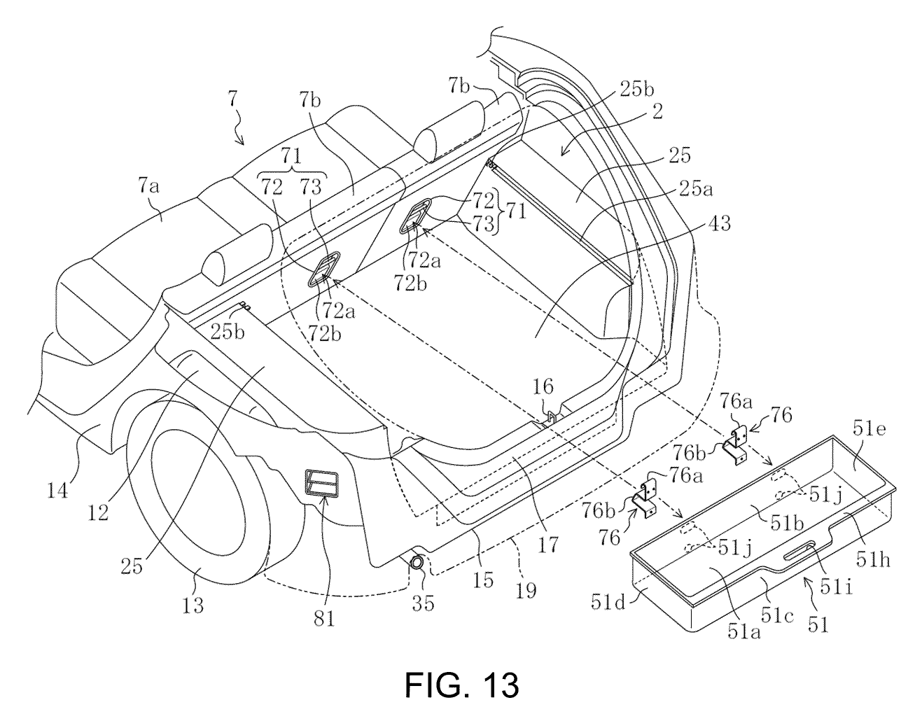

FIGS. 12 to 14 show Embodiment 3 of the present invention, and in this embodiment, the water receptor 51 is supported by a rear face of the seat back 7b of the rear seat 7 located forward of the rear cargo compartment 8. Note that, in FIG. 13, illustration of the liftgate 3 and the cargo cover 9 is omitted.

Specifically, in this embodiment, a support member 71 for supporting the water receptor 51 is formed in the rear face of each seat back 7b of the rear seat 7. Each support member 71 includes a body part 72 having a concave part 72a concaved into the seat back 7b (toward the front side in the unfolded state of the rear seat 7), and a support bar 73.

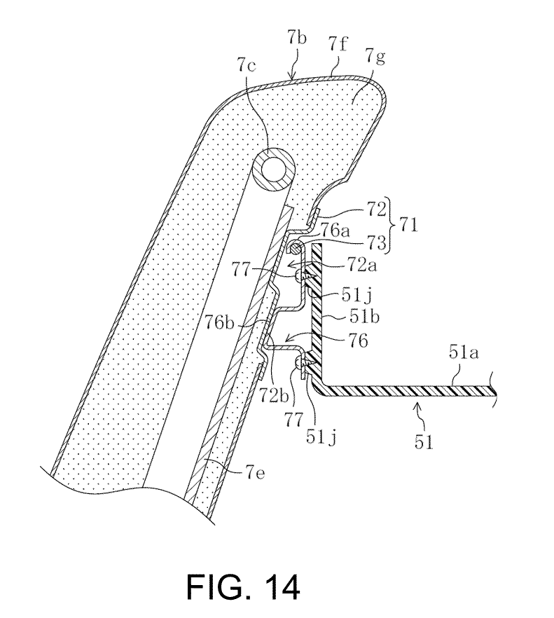

A rear seat back panel 7e (refer to FIG. 14) is provided in the vicinity of the rear face inside each seat back 7b (immediately inside of the outermost covering sheet 7f) substantially over the entire back face. This rear seat back panel 7e is made of iron, and is fixed to both the left-side and right-side side parts of the seat back frame 7c. The body part 72 is fixed to the rear seat back panel 7e of each seat back 7b. Note that, in FIG. 14, the reference numeral 7g indicates a pad.

An upper part of the concave part 72a in the body part 72 is greatly concaved inwardly to the seat back 7b compared with a lower part thereof. The support bar 73 of a circular cross-section is fixed to the upper part of the concave part 72a so as to extend in the left-and-right direction. A face corresponding to a bottom face in the lower part of the concave part 72a (a face facing to the rear) serves as a contact face 72b where a hook member 76, described later, contacts a contact part 76b.

As similar to Embodiments 1 and 2, the water receptor 51 is formed in a rectangular box shape having an opening on its upper side, and includes the bottom wall part 51a, as well as the front-side side wall part 51b, the rear-side side wall part 51c, the left-side side wall part 51d, and the right-side side wall part 51e which rise substantially perpendicularly with respect to the bottom wall part 51a from the entire periphery of the bottom wall part 51a. In this embodiment, as shown in FIG. 13, the hook member 76 corresponding to the attachment member for attaching the water receptor 51 to the seat back 7b (the support member 71) is fixed to two locations corresponding to the support member 71 in the front-side side wall part 51b, respectively. Each hook member 76 is attached and fixed to a front face of the front-side side wall part 51b by three tapping screws 77 (refer to FIG. 14). The locations in the front face of the front-side side wall part 51b where the tapping screws 77 are threadedly engaged are formed in a thickened part 51j (refer to FIGS. 13 and 14) where the thickness is greater than other parts.

The hook member 76 is formed form a plate member extending in the vertical direction. An upper end part of the hook member 76 is formed in a hook part 76a which is bent in an inverted U-shape, and this hook part 76a is hooked on the support bar 73 of the support member 71. A projecting part 76b is bent substantially in a C-shape so as to project to the front is provided in a lower part of the hook member 76. In a state where the hook part 76a is hooked on the support bar 73, the tendency of the water receptor 51 is to naturally rotate clockwise in FIG. 14 around the support bar 73 due to the weight of the water receptor 51. However, because the tip-end face (front face) of the projecting part 76b contacts the contact face 72b of the body part 72, the rotation is prevented so that the bottom wall part 51a of the water receptor 51 extends horizontally. In this way, the water receptor 51 is supported by the rear face of the seat back 7b in the unfolded state. In this supported state, the water receptor 51 is located below the mesh part 45e and above the floor of the rear cargo compartment 8 (at a height position close to the mesh part 45e), while overlapping with the entire area of the mesh part 45e when seen from above.

Similar to Embodiments 1 and 2, a projecting part 51h is formed at the upper end of the rear-side side wall part 51c of the water receptor 51, and a finger-hooking hole 51i is formed an a central part of the projecting part 51h in the horizontal direction. The operator hooks his/her fingers on the finger-hooking hole 51i and lifts the rear end part of the water receptor 51 to release the hook member 76 from the support bar 73 of the support member 71.

In this way, similar to Embodiments 1 and 2, the water receptor 51 removed from the support member 71 is set upon the sub-trunk insert 39 inside the rear cargo floor panel 32 so that it can be used as a trunk box where article(s) (which may be the dripping-wet article(s)) are accommodated.

Therefore, also in this embodiment, similar to Embodiments 1 and 2, drying out of the dripping-wet article can be facilitated, and the floor of the rear cargo compartment 8 can be prevented from getting wet by water drops fallen from the dripping-wet article. Further, similar to the case where the water receptor 51 is supported by the cargo compartment side trim panel 25, the supporting capability of the water receptor 51 can be improved.

The present invention is advantageous in the rear structure of the automobile provided with a cargo cover that divides the rear cargo compartment, in the rear part of the automobile and the passenger compartment.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A rear structure for an automobile comprising:
an interior pressure release vent disposed in a rear cargo compartment in a rear part of the automobile, the interior pressure release vent discharging air from a passenger compartment and the rear cargo compartment to an outside of the automobile;
a cargo cover disposed above the rear cargo compartment so as to divide the rear cargo compartment from the passenger compartment, the cargo cover having a mesh portion comprising reticulated through-holes passing through the cargo cover in a vertical direction; and
a water receptor disposed below the mesh portion of the cargo cover and above a floor of the rear cargo compartment, the water receptor positioned to receive water drops from the dripping-wet personal effect that is put on the mesh portion.

2. The rear structure for an automobile according to claim 1 wherein,
the water receptor is provided with an attachment for attaching the water receptor to the cargo cover.

3. The rear structure for an automobile according to claim 2 wherein,
the attachment is configured to attach the water receptor to the cargo cover such that a gap is formed therebetween.

4. The rear structure for an automobile according to claim 2 wherein,
the water receptor is configured to be selectively placed on the floor of the rear cargo compartment as a trunk box for storing the personal effects, instead of being attached to the cargo cover by the attachment.

5. The rear structure for an automobile according to claim 1 wherein,
the water receptor is supported on both left and right side walls of the rear cargo compartment.

6. The rear structure for an automobile according to claim 1 wherein,
the water receptor is supported on a backside of a seat back of a seat that is disposed frontward of the rear cargo compartment.

7. The rear structure for an automobile according to claim 1 wherein,
the water receptor is formed in a box shape with an opening on its upper side.

8. The rear structure for an automobile according to claim 1 wherein,
the water receptor is disposed so as to overlap with a whole area of the mesh portion in a top view.
